(19) United States
(12) Patent Application Publication
(10) Pub. No.: US 2005/0223316 A1
(43) Pub. Date: Oct. 6, 2005

(54) Compiled document type definition verifier

(75) Inventor: Pawel S. Veselov, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: SUN MICROSYSTEMS, INC., SANTA CLARA, CA (US)

(21) Appl. No.: 10/817,257

(22) Filed: Apr. 1, 2004

(51) Int. Cl. G06F 17/21; G06F 9/44

(52) U.S. Cl. 715/513; 717/115

(57) ABSTRACT

Provided is a method and an apparatus to verify an extensible Markup Language (XML) document against a compiled Document Type Definition (DTD). A DTD document can specify valid elements and the sequence of the valid elements in the XML document. During compilation, the elements of the DTD document are added to a structure, such as a tree. Consequently, nodes in the tree can contain elements, which are verified against the elements in the XML document. If there is a match between all the elements in the XML document and elements of the structure, then the XML document is valid. A valid XML document is thus verified and can be processed. Otherwise, an error can result, indicating an invalid XML document.

### BACKGROUND

1. Field of the Invention

The present invention relates to XML documents, and more specifically to verifying XML documents.

2. Description of the Related Art

Extensible Markup Language (XML) can be used to create files that can be exchanged via the Internet. For example, a file such as a document, can have XML tags that identify data and provide meaning to the data. Exemplary XML tags such as <message>, <to>, and <text> can be used in the document as follows: <message> <to>receiver@receiverAddress.com</to> <text>Hello</text> </message>. Typically, the file can be transferred from any system over the Internet to another system, where the file can be read and processed.

In complex documents, there can be many tags and other information, such as attributes, to identify the data. An exemplary attribute type can be CDATA, which identifies unparsed character data, typically known as a text string. Consequently, a document type definition (DTD) can specify the valid information and the arrangement of the information in the complex XML document 110. Without the DTD, software for error checking could be used to determine if all the tags are in the right order. However, error checking can add many lines of code and extend execution time when processing the XML document.

FIG. 1 is a diagram illustrating an XML DTD verifier 130. For example, in a system 100, an XML DTD verifier 130 can receive as input an XML document 110 and a DTD 120 to produce a DTD output 140, a verified XML document 150, or an error 160. The DTD output 140 can be a document with inserted attributes in the XML document 110 to add more meaning to the data in the XML document 110. Alternatively, the verified XML document 150 can be a document without the inserted attributes. If the XML document 110 does not have valid tags or has an invalid tag arrangement, then the XML DTD verifier 130 can produce an error 160.

The XML document 110 can be written without a DTD 120. However, without the DTD 120, the XML document 110 can be well formed, meaning that the writer can ensure that the tags and other information are properly written. However, this is difficult to accomplish except for the simplest documents. For complex XML documents 110, the DTD 120 can be included in the document. Alternatively, the DTD 120 can be in a separate file.

Large or complex XML documents 110 and DTDs 120 are typically processed by a desktop system executing the XML DTD verifier 130 because of the intensive memory and power requirements for verifying the XML documents 110. Specifically, in order to verify the XML document 110, the tags and other information in both the XML document 110 and DTD 120 should be parsed for verification. Parsing typically consumes many processing cycles for large or complex XML documents 110 and DTDs 120.

However, in devices such as wireless, mobile devices, verifying complex XML documents 110 is difficult to accomplish. Invariably, the device will consume too many resources while parsing. For example, if an Internet-enabled cell phone downloads the complex XML document 110, then verifying the document will eventually consume the limited battery power of the device. Further, even with unlimited power, the device could consume too many processing cycles verifying the XML document 110 because of the limited processing capability of the device, thus causing the inefficient operation of the device.

A current solution to verify XML documents 110 on devices is to use an intermediary system accessible to the device. For example, a desktop system connected to the Internet can verify XML documents 110 and then send the verified XML document 150 to the device. However, this solution suffers from the need to access an intermediary system. Without the intermediate system, the device cannot download and verify the complex XML document 110.

Accordingly, what is needed is a method and an apparatus for verifying complex XML documents with the use of a DTD on a device with limited resources.

### SUMMARY

Broadly speaking, the present invention is a method and an apparatus for verifying an XML document with the use of a compiled DTD. It can be appreciated that the present invention can be implemented in numerous ways, such as a process, an apparatus, a system, a device or a method on a computer readable medium. Several inventive embodiments of the present invention are described below.

In one embodiment, a method can include operations for obtaining an XML document and accessing a compiled document type definition (DTD) for the XML document. Further, the embodiment can include an operation to verify the XML document using the compiled DTD.

Another exemplary embodiment includes a system having a extensible markup language (XML) document that includes a plurality of tags and a compiled document type definition (DTD) that is capable of verifying the plurality of tags in the XML document.

Further, in yet another embodiment, a computer program embodied on a computer readable medium for verifying an XML document can include instructions for obtaining an XML document and instructions for generating a compiled DTD. The embodiment can also include instructions for verifying an XML document against the compiled DTD.

Other aspects of the invention will become apparent from the following detailed description, taken in conjunction with the accompanying drawings, illustrating by way of example the principles of the invention.

### BRIEF DESCRIPTION OF THE DRAWINGS

Embodiments of the invention may best be understood by reference to the following description, taken in conjunction with the accompanying drawings in which:

FIG. 1 is a diagram illustrating an extensible markup language (XML) document type definition (DTD) verifier;

FIG. 2 is a diagram illustrating a device, in accordance with an embodiment of the invention;

FIG. 3A is a diagram illustrating a compiled DTD verifier, in accordance with an embodiment of the invention;

FIG. 3B is a method illustrating operations for a compiled DTD verifier, in accordance with an embodiment of the invention;

FIG. 4 is a method illustrating other operations for DTD compilation, in accordance with an embodiment of the invention;

FIG. 5A is a diagram illustrating a tree structure, in accordance with an embodiment of the invention;

FIG. 5B is a diagram illustrating a stack in relation to the tree, in accordance with an embodiment of the invention;

FIG. 6 is a method illustrating operations verifying an XML document, in accordance with an embodiment of the invention; and

FIG. 7 is another method illustrating operations verifying an XML document, in accordance with an embodiment of the invention.

### DETAILED DESCRIPTION

The following embodiments describe a method and an apparatus for verifying an XML document with a compiled DTD verifier. For example, one or more DTD verifiers can validate information in the XML document using the limited resources of a device such as a mobile phone. However, other devices with or without limited resources are possible as long as the XML document is verified with a compiled DTD.

In one embodiment, a DTD document can be converted into compiled code and executed against the XML document. Then, the XML document can be downloaded to the device having the compiled DTD for verification. In another embodiment, if the XML document includes a DTD, then the DTD can be ignored. Further, in other exemplary embodiments, XML documents can have different versions that can be discarded if the version does not match the version of the compiled DTD. Alternatively, multiple compiled DTDs can handle the different versions of XML documents. Regardless of the compiled DTD versions, the output from the compiled DTD verifier can be valid or invalid. It will be obvious, however, to one skilled in the art, that the present invention may be practiced without some or all of these specific details. In other instances, well known process operations have not been described in detail in order not to unnecessarily obscure the present invention.

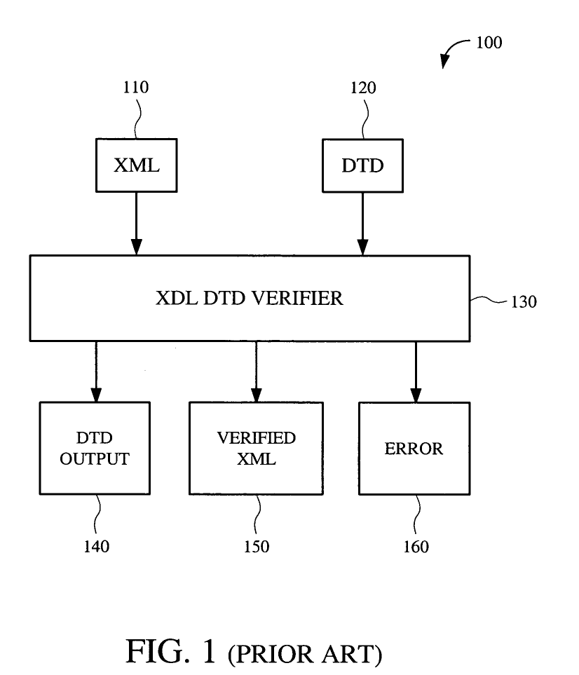

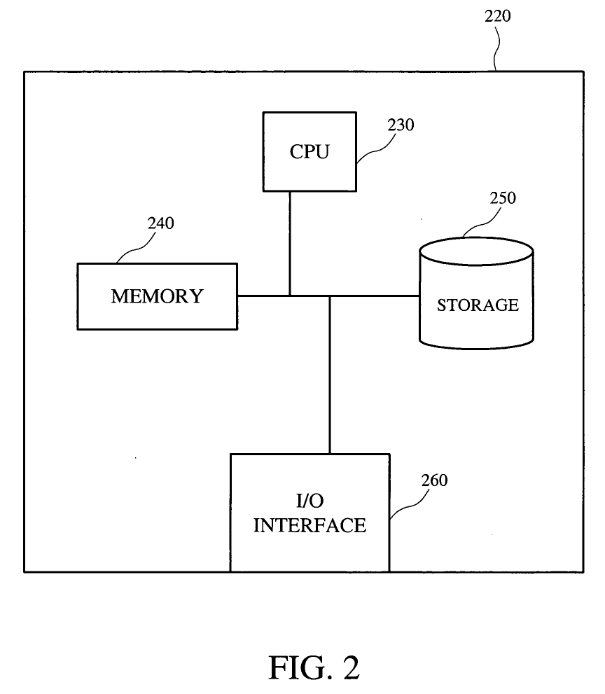

FIG. 2 is a diagram illustrating a device 220, in accordance with an embodiment of the invention. The device 220, such as a mobile phone, can include components such as a central processing unit (CPU) 230, a memory 240, a storage device 250, and an I/O interface 260. Other devices can have more or less components, as long as the device can verify the XML document 110 (FIG. 1) with a compiled DTD. Further, the device 220 can include software to enable the operation of applications designed for the device 220. For example, software such as Java 2 Platform Micro Edition (J2ME) by Sun Microsystems permits the creation of applications for wireless and mobile devices such as personal digital assistants (PDAs) and mobile phones. However, other software enabling the operation of applications is possible, as long as the software permits the operation of a compiled DTD verifier.

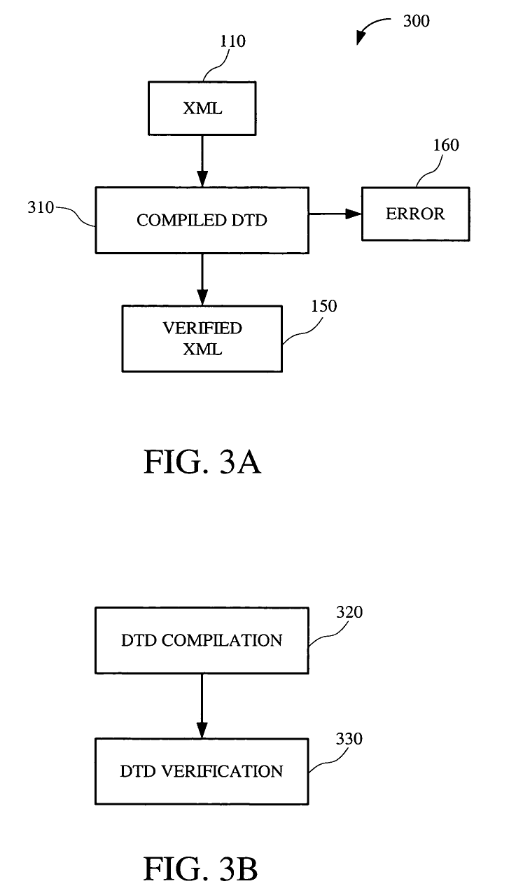

Accordingly, FIG. 3A is a diagram illustrating a compiled DTD verifier 310, in accordance with an embodiment of the invention. For example, the XML document 110 can enter the device 220 via the I/O interface 260. Thereafter, a compiled DTD verifier 310 using a compiled DTD stored in the memory 240 or the storage device 250 can receive the XML document 110 as input. Consequently, the CPU 230 processes the XML document 110 using the compiled DTD verifier 310 and produces the verified XML document 150 or the error 160. In other embodiments, the compiled DTD verifier 310 can also produce the DTD output 140 with inserted attributes in the verified XML document 150. By using the compiled DTD verifier 310 instead of the traditional XML DTD verifier 130, the DTD 120 need not be parsed during DTD verification, thus saving resource consumption on the device 220.

FIG. 3B is a method illustrating operations for the compiled DTD verifier 310, in accordance with an embodiment of the invention. In an exemplary embodiment, an operation 320 can occur for DTD compilation, thus creating the compiled DTD. Consequently, in operation 330, DTD verification can occur using the compiled DTD. Returning to operation 320, DTD compilation receives a DTD document with several atoms, such as XML tags. An example of a single XML tag is <!DOCTYPE [ ]>, which defines the name of the document type, may specify an external identifier, and a set of markup declarations.

The set of markup declarations further define the document structure. Exemplary markup declarations can include element declarations, attribute list declarations, entity declarations, and notation declarations. There may also be processing instructions and comments within markup declarations. The DTD document does not include entity and notation declarations and consequently the DTD verification in operation 330 does not process the entity and notation declarations. The entity and notation declarations are mostly used to reference other DTD documents, which can be done by an XML parser capable of reading the DTD document.

Accordingly, the element and attribute list declarations remain for processing. An exemplary attribute list declaration can be <!ATTLIST NAME (NAME TYPE DEFAULT)*>, where NAME is the name of the element the attribute list belongs to, and the content in angle brackets is the definition of a single attribute. After capturing all the attribute declarations from the DTD document, there will be a set of attribute definitions for all the elements in the DTD document. For example, an array can reference the attribute definitions with a hash table such as Hashtable attrs {key: element name, value: attribute array}.

An exemplary element declaration can be <!ELEMENT NAME SPEC>. SPEC can be an element content specification, and can be EMPTY, ANY, MIXED, or CHILDREN. EMPTY disallows nesting and ANY allows nesting. MIXED allows “#PCDATA,” optionally followed by set of element names separated by a “pipe” sign. MIXED examples can include (#PCDATA) and (#PCDATA|BR|P). CHILDREN can be a recursive definition of elements such as:
children=(choice|seq) (‘?’|‘*’|‘+’)?
cp=(Name|choice|seq) (‘?’|‘*’|‘+’)?
choice=‘(’S?cp (S?‘|’S?cp)+S?‘)’
seq=‘(’S?cp (S?‘,’S?cp)*S?‘)’
   where ‘cp’ is a “content particle”.

Consequently, there can be an infinite level of nesting allowed within the element declaration. Every content particle can be represented as a sequence, choice, or an actual name. For sequence and choice, cp could return an array of other content particles. Every content particle could also have attributes that specify whether multiple occurrences of the cp entry is allowed, and what is the minimal occurrences of the cp entry. The occurrences restraint can be specified by the ‘?’, ‘*’ or ‘+’ symbol after the content particle, as shown with the following examples:

| Modifier | Multiple | Minimum |
|---|---|---|
| (none) | false | 1 |
| ? | false | 0 |
| * | true | 0 |
| + | true | 1 |

Accordingly, every element can have a content of EMPTY, ANY, MIXED, or CHILDREN such that MIXED and CHILDREN can refer to the content particle. One content particle can be called the “root” content particle for the element and can represent a root of a tree used in operation 330.

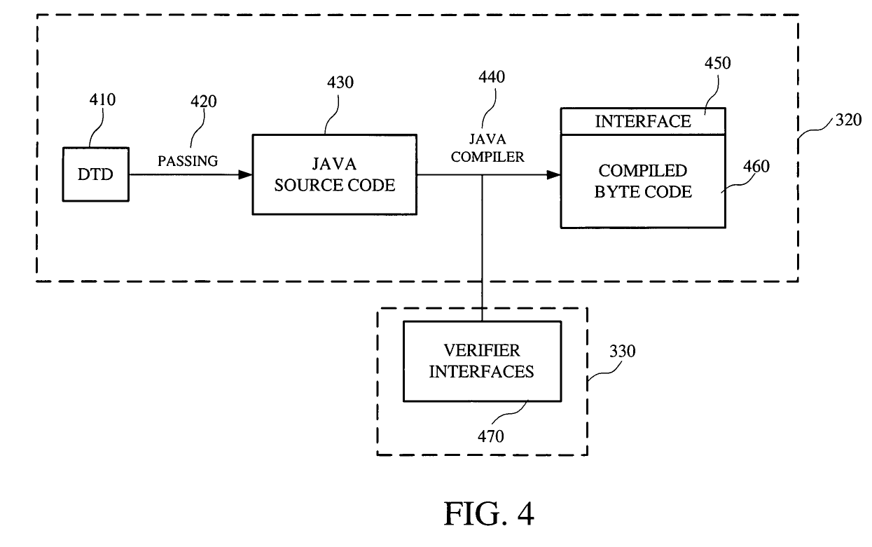

FIG. 4 is a method illustrating other operations for DTD compilation, in accordance with an embodiment of the invention. Operation 320 illustrates the DTD compilation of a DTD document 410 having elements, as described in reference to FIG. 3. Particularly, the DTD document 410 specifies the root element and the possible nesting of the elements. Then, the DTD document 410 undergoes a parsing operation 420, which generates Java source code 430. In other exemplary embodiments, other parsing operations of DTD documents that generate any type of source code for any compiler are possible, as long as the compiler produces a compiled DTD. Then, for example, a Java compiler 440 can receive the Java source code 430, while accounting for a verifier interface 470, to produce the compiled DTD. Consequently, the compiled DTD can include an interface 450 and compiled byte code 460.

The Java compiler 440 compiles the Java source code 430 with the verifier interface 470, to create the interface 450. The interface 450 can match with an interface in the DTD verification operation to permit the use of particular code within the compiled DTD when verifying the XML document 110. Thus, the interface 450 permits access to portions of the compiled DTD for execution in the compiled DTD verifier 310.

During DTD compilation, the element and attribute list declarations are used to build a structure of objects defining all element contexts and attribute lists for the elements. Prior to creating an object, the structure is checked to determine if an object with the same parameters does not already exist. If the object with the same parameters exists, then the existing object is referenced instead.

For example a first declaration for “P” and a second declaration for “DIV” can be:
<!ATTLIST P white-space #CDATA #IMPLIED text-align #CDATA #IMPLIED>
<!ATTLIST DIV white-space #CDATA #IMPLIED text-align #CDATA #IMPLIED>

In both declarations, both include “white-space” and “text-align” attributes with the same type information. Further, the attribute context for both “P” and “DIV” are the same. Because complex DTDs can reuse a lot of the same attributes and elements, the objects created in the structure can be included once and referenced when repeated in other declarations.

The structure can include a root object called “data,” which can provide references to an “Element content” by an element name, “Attribute list content” by an element name, and the name of the root element. “Element content” describes possible content for an element and can be one of EMPTY, ANY, MIXED, or CHILDREN, and a reference to the topmost content particle. Further, the content particle can include the attributes of CHOICE, SEQUENCE, or NAME.

For a NAME type, an element name can be returned after DTD compilation. For CHOICE and SEQUENCE, an array of referenced content particles can be returned. The object can also provide attributes that specify the minimal occurrences of the content particle, and whether multiple occurrences of the content particle is allowed.

The “Attribute list content” object can return the attribute type, as defined in the DTD (e.g. CDATA, ID, IDREF, and so on), and the default declaration of this attribute, which can include IMPLIED, REQUIRED or FIXED. For a FIXED default, an actual default value can be provided. The object described above can adhere to interfaces defined by the DTD verification, so the compiled DTD verifier 310 can retrieve necessary information.

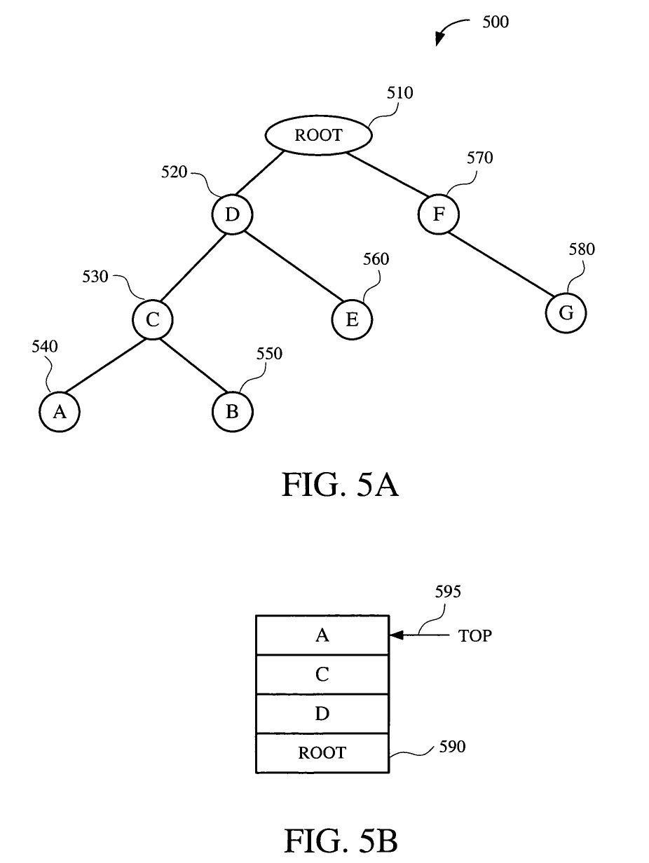

FIG. 5A is a diagram illustrating a tree structure, in accordance with an embodiment of the invention. A tree 500 can have multiple nodes such as root 510, node-D 520, node-C 530, node-A 5440, node-B 550, node-E 560, node-F 570, and node-G 580. Each node of the tree 500 can be added based on the order an element appears in the DTD document 410. Further, each node has occurrences that specify how many times the node was traversed. Between the nodes are links that specify an operation. Accordingly, when traversing the tree 500 from the root 510, an operation is viewed and processed before accessing the element in the node. In one embodiment, the tree 500 can be used during DTD verification. However, in other exemplary embodiments, other structures can be used during DTD verification as long as the structures can store elements and operations. For example, other exemplary structures can include linked lists or other statically allocated and dynamically allocated structures.

DTD verification can include exemplary functions such as create(document ID), start(root element), attach(element), Boolean verifyText(text), elementDone( ), and verifyAttrs(& element attributes). Other exemplary functions are possible for other structures as long as the functions facilitate DTD verification.

Regarding the exemplary functions, create(document ID) generates a new verifier instance, based on the specified XML document ID. The XML document ID helps to find precompiled data for a specific DTD. Start(root element) begins the DTD verification process. Accordingly, calling the function start(root) begins the DTD verification process and can check that the root 510 is allowed to be a first element in the XML document 110.

Attach(element) attaches an element to the tree 500 and checks that the position of the element is allowed. Next, boolean verifyText(text) verifies whether text is allowed within the current document position. Because not all the parsers are able to determine whether text is ignorable, such as a whitespace, the function returns a boolean flag if text is not allowed. ElementDone( ) indicates that the current element has been closed and there are no more elements to attach.

VerifyAttrs(& element attributes) checks that the attributes specified for an element are correct. For example, correctness can indicate whether all required attributes are present, whether all attributes are in the correct form, and whether there are any attributes that are not expected in the element. VerifyAttrs( ) receives the element name, and finds the attribute information for the element. Then, the list of attributes is compared to the list of attributes specified to the function. If there are any required attributes that are missing, then signal an error. If there are any extra attributes that are not specified, then the extra attributes are removed. If there are any attributes that are missing, then they are added to the attribute list with their default values.

FIG. 5B is a diagram illustrating a stack 590 in relation to the tree 500, in accordance with an embodiment of the invention. The stack 590 tracks the traversal of the tree 500 by keeping a history of visited nodes. For example, if the stack 590 includes layers such as the root 510, node-D 520, node-C 530, and node-A 540, then a top 595 can indicate the top of the stack 590. By popping each layer of the stack, the top 595 can keep track of the current node in the tree 500. Further, each layer can specify a level in the tree 500. Accordingly, the root 510 can specify level 0, the node-D 520 can specify level 1, the node-C can specify level 2, and the node-A can specify level 3.

As each element is attached to the tree 500 in a node, a layer is added to the stack 590. When an element is closed, the top 595 decreases by one layer. Every element has an associated runtime content. The runtime content refers to a “particle,” which is created around a content particle, as previously described. The particle has only one function, called “verify( ),” which receives an element name as an argument, and returns another particle, which can be used to continue the DTD verification. Otherwise, verify( ) returns NULL if match was not found or signals an error.

The runtime content takes every result of the function and substitute the current particle with the result. The particle has “occurrences,” which counts the number of times the particle was matched, and “index,” which counts a position within sub particles. If the particle is created on a content particle that was bound to another particle, then the particle will bear a reference to that “parent” particle. If a content particle has a type which is NAME, then verify( ) returns the parent particle if a specified name matches the content particle's name. Otherwise, the function returns NULL. The runtime content can include verify(element name), verifyClose( ), and verifyText(string data).

Verify(element name) can determine that if content is of type EMPTY, then signal an error. Further, if content is of type ANY, then return. If a non-NULL result is returned, then the result becomes the new current particle. Otherwise an error is signaled. VerifyClose( ) can determine that if content is of type ANY, then return. The function also calls verify( ) on the current particle, and sets the result as a new current particle until the result is NULL. If there is an error, then it could be signaled from the particle. Further, verifyText(string data) can check that the content type is MIXED. If the content type is not MIXED, then signal an error. Accordingly, each element in the XML document 110 can be matched to a node in the tree 500. Otherwise, an error results.

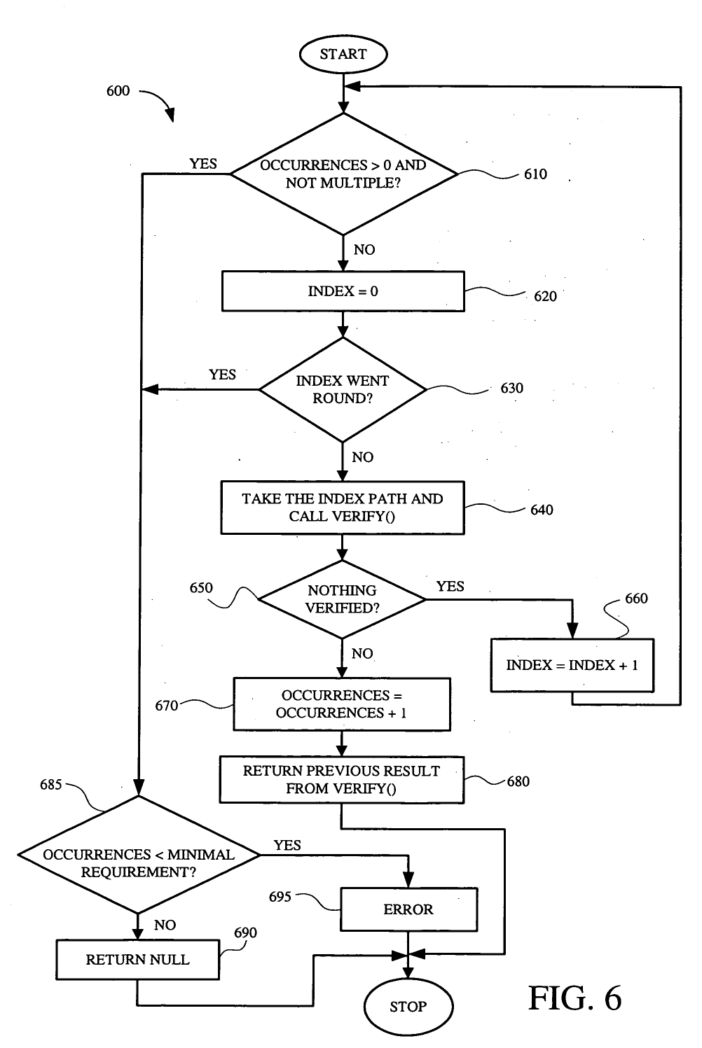

FIG. 6 is a method illustrating operations verifying an XML document, in accordance with an embodiment of the invention. If the content particle is CHOICE, then the DTD document 410 did not specify a particular order of the elements. A CHOICE method 600 begins by determining if the occurrences in a node is greater than zero and is not a multiple in operation 610. A multiple signifies that the content particle occurs more than once. If yes, then in operation 685, there is a determination whether the occurrences are less than the minimal requirement. If so, then signal an ERROR in operation 695 and stop the CHOICE method 600. If the response is no in operation 685, then in operation 690 return NULL to indicate that no match exists in the tree 500 and stop the CHOICE method 600. Alternatively, in operation 610, if the answer is no, then index is assigned zero in operation 620.

Index tracks the position of the level during the traversal of the tree 500. In operation 630, if the index went round, then proceed to operation 685. Otherwise, in operation 640, take the index path and call verify( ) with the current element. If there is nothing verified in operation 650, then index is incremented by one in operation 660 and returns to operation 610.

Alternatively, if the element is verified, then occurrences is incremented by one in operation 670. Further, in operation 680, if the element was verified, then return the previous result from verify( ). Consequently, the CHOICE method 600 stops. Eventually, any expression that matches will produce a traversal to the deepest level of the tree 500. The deepest level, such as node-A 540 can store a tag name such as “DIV.” Accordingly, if every element verifies, then the tag name is eventually returned.

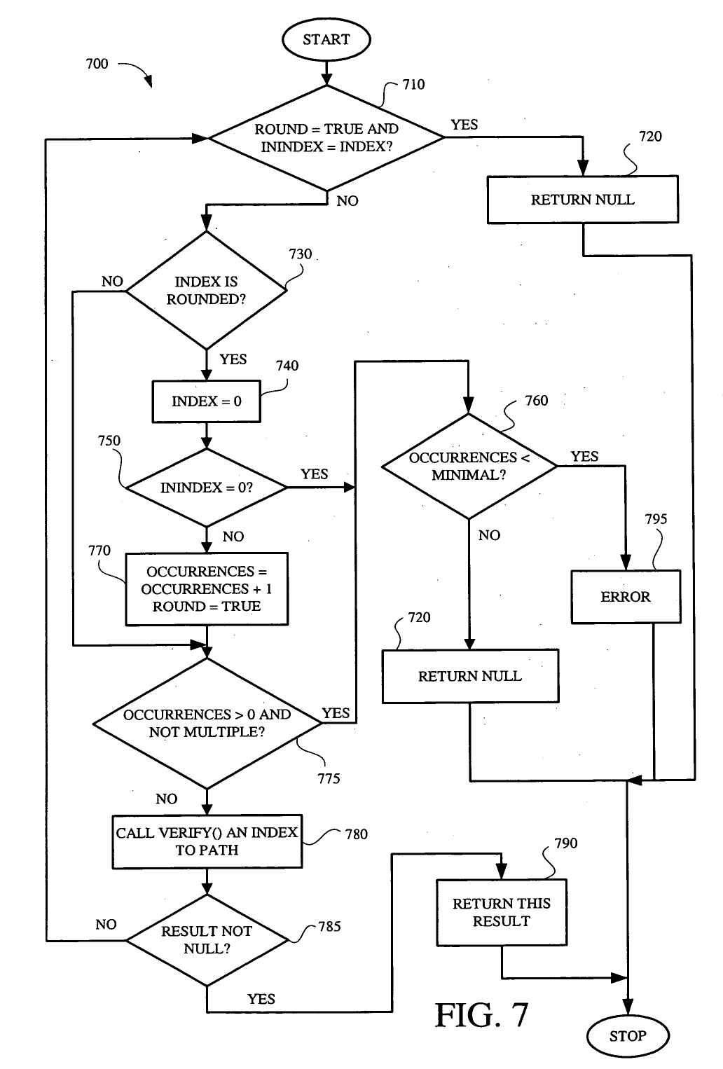

FIG. 7 is another method illustrating operations verifying an XML document, in accordance with an embodiment of the invention. If the content particle is SEQUENCE, then the DTD document 410 specified a particular order of the elements. A SEQUENCE method 700 begins in operation 710 by determining if the round variable is TRUE and inindex is assigned index. If inindex equals index, then return NULL in operation 720 to indicate that there is no operation to perform. Otherwise, determine if index is rounded in operation 730. If the index is rounded, then set index to zero in operation 740 and determine if inindex equals zero in 750. If inindex is zero, then determine if occurrences is less than minimal in operation 760. If yes, then signal an ERROR in 795 and stop the SEQUENCE method 700. Alternatively, return NULL in operation 720 and then stop the SEQUENCE method 700.

From operation 730, if the index is not rounded, then determine if occurrences is greater than zero and not a multiple in operation 775. Further, if inindex is not zero then occurrences is incremented by one and round is assigned TRUE in operation 770. Consequently, there is a determination of whether occurrences is greater than zero and not a multiple in operation 775. If yes, then in operation 760, determine whether occurrences is less than minimal. Following this path leads to signaling an ERROR or returning NULL.

Alternatively, from operation 775, call verify( ) and index to a path in the tree 500 in operation 780. Then, in operation 785, determine whether the result is not NULL. If not, then return to operation 710. Otherwise, return the result in operation 790 and stop the SEQUENCE method 700.

Other exemplary embodiments are possible using other structures with verification algorithms such as CHOICE and SEQUENCE. The verification algorithms are exemplary. Other verification algorithms are possible as long as the XML document 110 can be verified against a compiled DTD. Specifically, the compiled DTD can receive a structure such as the tree 500 to verify the XML document 110.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it can be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. A method, comprising:
obtaining an XML document;
accessing a compiled document type definition (DTD) for the XML document; and
verifying the XML document using the compiled DTD.

2. A method of claim 1, wherein verifying the XML document further includes creating a structure corresponding to a DTD document.

3. A method of claim 2, further including traversing the structure to verify the XML document.

4. A method of claim 3, further including storing layers in a stack to maintain a history.

5. A method of claim 1, wherein accessing the compiled DTD further includes parsing a DTD document to generate source code.

6. A method of claim 5, wherein parsing the DTD to generate the source code further includes compiling the source code with a verifier interface to generate the compiled DTD.

7. A method of claim 6, further including matching an interface in the compiled DTD to access portions of the compiled DTD during verification.

8. A method of claim 1, wherein verifying the XML document using the compiled DTD further includes executing a verification algorithm against a structure, the verification algorithm being capable of distinguishing an order of elements in a DTD document.

9. A method of claim 1, wherein verifying the XML document using the compiled DTD further includes generating one of an error, a verified XML document, and the verified XML document with an inserted attribute.

10. A system, comprising:
an extensible markup language (XML) document including a plurality of tags; and
a compiled document type definition (DTD) capable of verifying the plurality of tags in the XML document.

11. A system of claim 10, further having a structure capable of verifying the tags in the XML document, wherein the tags are capable of identifying and providing meaning to data in the XML document.

12. A system of claim 11, wherein the structure is a tree capable of storing unique occurrences of the plurality of tags.

13. A system of claim 12, further including a stack for tracking a history of visited nodes in the tree.

14. A system of claim 10, further including an interface coupled to the compiled DTD, the interface being capable of providing access to portions of the compiled DTD.

15. A system of claim 14, wherein a verifier interface is compiled with source code to generate the interface.

16. A computer program embodied on a computer readable medium for verifying an XML document, comprising:
instructions for obtaining an XML document;
instructions for generating a compiled DTD; and
instructions for verifying an XML document against the compiled DTD.

17. A computer program of claim 16, further including instructions for generating a structure capable of verifying the XML document.

18. A computer program of claim 16, further including instructions for parsing a DTD document to generate a compiled DTD.

19. A computer program of claim 17, further including instructions for tracking a history in a stack relating to the structure.

20. A computer program of claim 17, further including instructions for determining the order of elements in the XML document within the structure.

21. A computer program of claim 17, further including instructions for adding nodes to a tree defined as the structure.
